(19) United States
(12) Patent Application Publication
(10) Pub. No.: US 2005/0088667 A1
(43) Pub. Date: Apr. 28, 2005

(54) Absolute position encoder requiring less than one encoding track per bit

(76) Inventor: Chiau Woon Yeo, Penang (MY)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/692,867

(22) Filed: Oct. 23, 2003

(51) Int. Cl. G01B 11/14; G01D 5/34

(52) U.S. Cl. 356/617; 250/231.13

(57) ABSTRACT

An absolute encoder for measuring the position of a surface is disclosed. The encoder includes first and second encoding tracks. Each encoding track includes a code strip imaging system and an array of n photodetectors, where n>1. Each code strip imaging system generates an image from a code strip that is focused on the corresponding array of photodetectors. Each image includes alternating dark and light stripes. The width of the first code strip is chosen such that ndᵢ=Dᵢ, where dᵢ is the width of the photodetectors in the array in the i^{th} encoding track and Dᵢ is the width of the stripes in the code strip image in that track. The widths of the stripes and photodetectors are chosen such that d₁=nd₂.

### FIELD OF THE INVENTION

The present invention relates to a position encoding apparatus and method.

### BACKGROUND OF THE INVENTION

An absolute encoder provides a readout of the position of an apparatus relative to some predetermined location. For example, an absolute shaft encoder provides a readout of the number of degrees the shaft would need to be rotated to return to a predetermined starting position.

Conventional absolute encoders utilize a series of fiducial marks and detectors to provide the above-described readout. In general, if the device provides an N-bit readout of the location, there are N separate sets of fiducial marks, one per bit. The marks for each set are arranged as a “track”. There are also N separate detectors, one per track. The fiducial marks are normally placed on the moving apparatus, and the detectors are placed on a device that is fixed relative to the moving apparatus such that each set of fiducial marks moves past the corresponding detector as the apparatus moves. Each detector provides a signal when one of the associated fiducial marks passes the detector. However, systems in which the detectors are on the moving apparatus and the fiducials are on the fixed surface are also known,

This type of arrangement has severe alignment requirements that substantially increase the cost of encoders based on this type of design. In particular, the individual sets of fiducial marks must be aligned relative to one another. Similarly, detectors must also be aligned relative to one another. The alignment tolerance is determined by the smallest distance that is to be resolved. Hence, systems in which N is large are particularly costly both in terms of the number of encoding tracks and detectors and in terms of the alignment costs.

### SUMMARY OF THE INVENTION

The present invention includes an encoder for measuring the position of a surface. The encoder includes first and second encoding tracks. The first encoding track includes a first array of n photodetectors, where n>1, each photodetector is characterized by a width d₁ and a first code strip imaging system. The first code strip imaging system generates an image from a first code strip attached to the surface on the first array. The image includes alternating dark and light stripes, the stripes having a width of D₁. The dark stripes having a lower luminosity than the white stripes. The width of the first code strip is chosen such that nd₁=D₁. The code strip image moves in a first direction with respect to the first array. The distances d₁ and D₁ are measured in a direction parallel to the first direction. The second encoding track includes a second array of n photodetectors in which each photodetector is characterized by a width d₂, and a second code strip imaging system for generating an image from a second code strip attached to the surface on the second array. The image of the second code strip includes alternating dark and light stripes, the stripes having a width of D₂. The width of the photodetectors in the second array is chosen such that nd₂=D₂. The code strip image moves in a first direction with respect to the first array. The distances d₂ and D₂ are measured in a direction parallel to the first direction, and d₁=nd₂. The encoder preferably includes a plurality of detector circuits, each detector circuit converts a light intensity signal from a corresponding one of the photodetectors to a channel signal that switches between the first and second logic states when the code strip moves relative to the array. In one embodiment of the present invention, a decoding circuit converts the channel signals into a digital signal that increases monotonically with the position of the code strip relative to a reference point.

### BRIEF DESCRIPTION OF THE DRAWING

FIG. 1 illustrates a transmissive encoder.

FIG. 2 illustrates a reflective encoder.

FIG. 3 illustrates an imaging encoder.

FIG. 4 illustrates a conventional 4-bit absolute encoder.

FIG. 5 illustrates a prior art two-channel encoder design.

FIG. 6 is a graph of the amplitude of the output of each photodetector as a function of position of the code strip image.

FIG. 7 illustrates the channel A and channel B signals when the code strip is moving in the direction shown by arrow 23 in FIG. 5.

FIG. 8 illustrates a 4-bit encoder according to one embodiment of the present invention.

FIG. 9 illustrates the outputs of the detector circuits on lines 91-94 as a 4-bit integer that cycles through 16 distinct states as the code strips move past the detector arrays.

### DETAILED DESCRIPTION OF THE PREFERRED EMBODIMENTS OF THE INVENTION

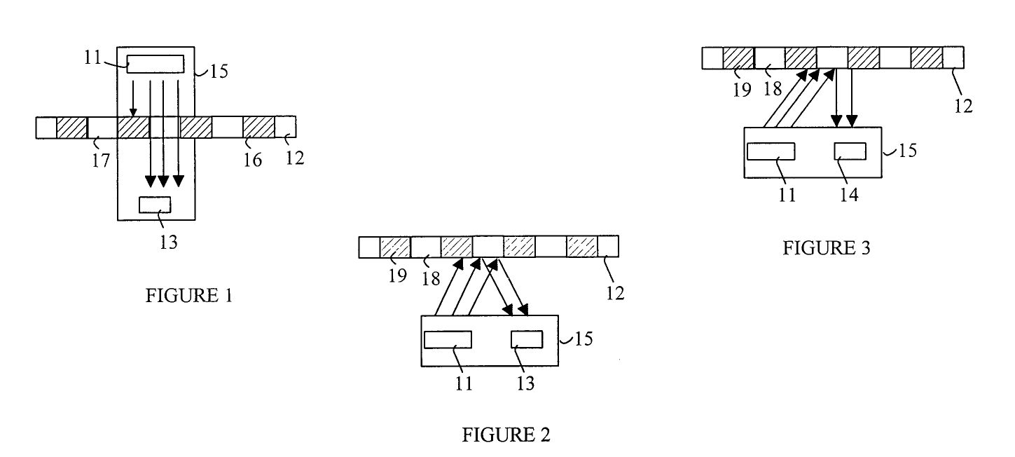

Refer now to FIGS. 1-3, which illustrate some typical encoder designs. The encoder can be divided into an emitter/detector module 15 and a code wheel or code strip. Module 15 includes an emitter 11 that illuminates a portion of the code strip 12. A detector 13 views the illuminated code strip. The emitter typically utilizes an LED as the light source. The detector is typically based on one or more photodiodes. FIG. 1 illustrates a transmissive encoder. In transmissive encoders, the light from the emitter is collimated into a parallel beam by a collimating optic such as a lens that is part of the emitter. Code strip 12 includes opaque stripes 16 and transparent stripes 17. When code strip 12 moves between emitter 11 and detector 13, the light beam is interrupted by the opaque stripes on the code strip. The photodiodes in the detector receive flashes of light. The resultant signal is then used to generate a logic signal that transitions between logical one and logical zero.

FIG. 2 illustrates a reflective encoder. In reflective encoders, the code strip includes reflective stripes 18 and absorptive stripes 19. Again, the emitter includes a collimating optic such as a lens. The light from the emitter is reflected or absorbed by the stripes on the code strip. The reflected light is imaged onto the photodiodes in the detector. The output from the photodetectors is again converted to a logic signal.

FIG. 3 illustrates an imaging encoder. An imaging encoder operates essentially the same as the reflective encoder described above, except that module 15 includes imaging optics that form an image of the illuminated code strip on the detector 14.

In each of these types of encoders, an image of one portion of the stripe pattern is generated on the photosensitive area of a photodiode in an array of photodiodes. To simplify the following discussion, drawings depicting the image of the code strip and the surface area of the photodetectors on which the image is formed will be utilized. In each drawing, the image of the code strip will be shown next to the photodiode array to simplify the drawing. However, it is to be understood that, in practice, the image of the code strip would be projected onto the surface of the photodiode array. In addition, to further simplify the drawings, the light source and any collimating or imaging optics are omitted from the drawings.

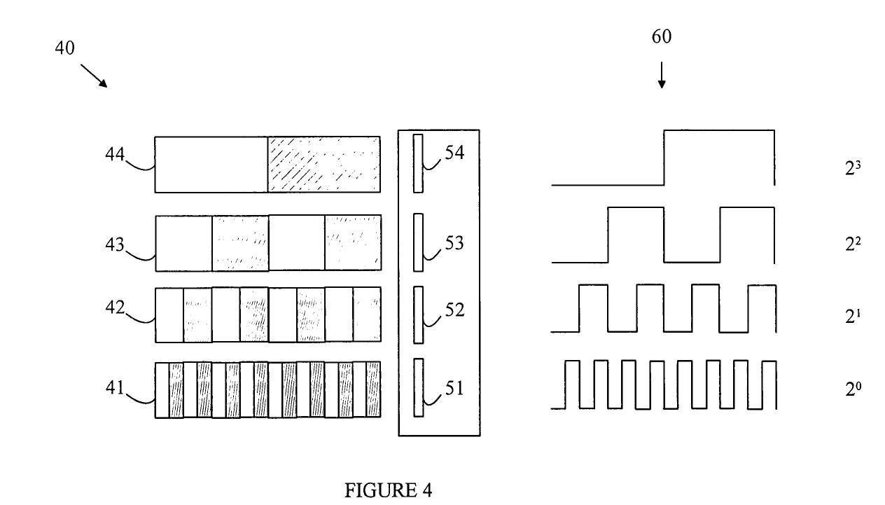

Refer now to FIG. 4, which illustrates a conventional 4-bit absolute encoder 40. The code strip image pattern of stripes is shown at 41-44. Each code strip pattern is viewed by a corresponding photodiode. The photodiodes corresponding to patterns 41-44 are shown at 51 to 54, respectively. The signals from the photodiodes are shown at 60 for the 4 bits corresponding to 2⁰ to 2³. As can be seen from this figure, the 4-bit absolute encoder will requires 4 tracks, each having a code strip and a photodiode. As noted above, an n-bit absolute encoder requires n-code strips and n-photodiodes that must be aligned with the code strip images and each other.

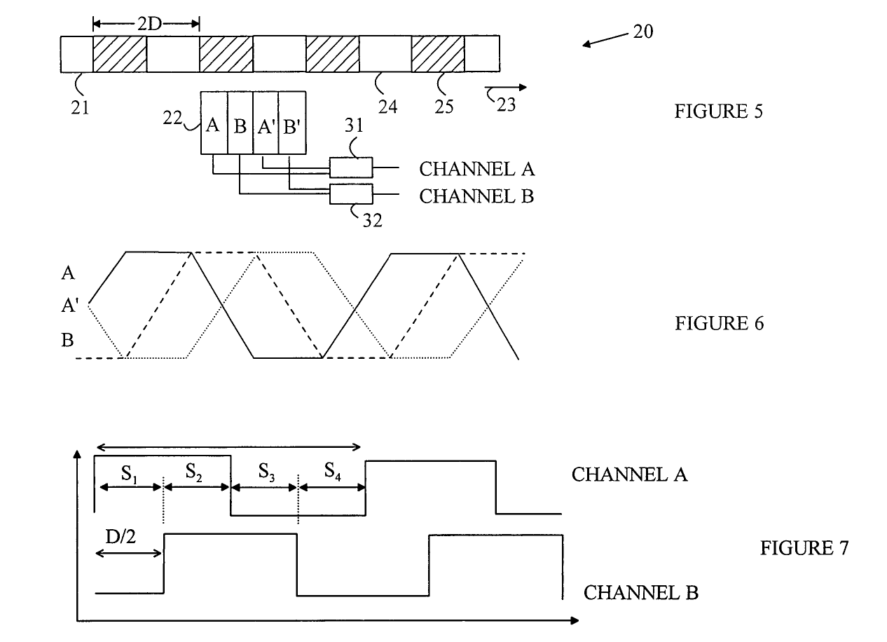

Refer now to FIG. 5, which illustrates a prior art two-channel encoder 20 design that has been utilized in single track encoders that detect the relative motion of the code strip. Encoder 20 includes a code strip that is imaged to form an image 21 that is viewed by a detector array 22. The image 21 of the code strip consists of alternating “white” and “black” stripes shown at 24 and 25, respectively. Denote the width of each stripe in the direction of motion of the code strip by D. The direction of motion is indicated by arrow 23. For the purposes of this example, it will be assumed that when a white stripe is imaged on a detector, the detector outputs its maximum signal value, and when a black stripe is imaged on the detector, the detector outputs its minimum value. It will also be assumed that the detector outputs an intermediate value when only a portion of a white stripe is imaged onto the detector.

Detector array 22 is constructed from 4 photodetectors labeled A, A′, B, and B′. Each photodetector has an active area with a width equal to D/2. The A′ and B′ detectors are positioned such that the A′ and B′ detectors generate the complement of the signal generated by the A and B detectors, respectively. The outputs of the A, A′, and B photodetectors are shown in FIG. 6, which is a graph of the amplitude of the output of each photodetector as a function of position of the code strip image. To simplify FIG. 6, the output of the B′ photodetector has been omitted.

The signals generated by these detectors are combined by detector circuits 31 and 32 to generate two logic channel signals that are 90 degrees out of phase as shown in FIG. 7. FIG. 7 illustrates the channel A and channel B signals when the code strip is moving in the direction shown by arrow 23 in FIG. 5. If the code strip were to move in the opposite direction, the channel B signal would lead the channel A signal; however, the two signals would still be 90 degrees out of phase.

Circuits for converting the photodiode output signals to the channel signals shown in FIG. 6 are known in the art, and hence, will not be discussed in detail here. For the purposes of this discussion, it is sufficient to note that the channel signal corresponding to a pair of photodiode output signals such as A and A′ switches between logical one and logical zero at the points at which the output of detector A is equal to the output of detector A′.

The two channel signals provide a measurement of the direction of motion of the image of the code strip relative to the detector array. In addition, the two channel signals define 4 states that divide the distance measured by one black and one white stripe into quarters. The 4 states correspond to a two-bit binary number in which the first bit is determined by the value of the channel A signal and the second bit is determined by the value of the channel B signal. Hence, this type of system has an accuracy equal to half of the width of one of the stripes.

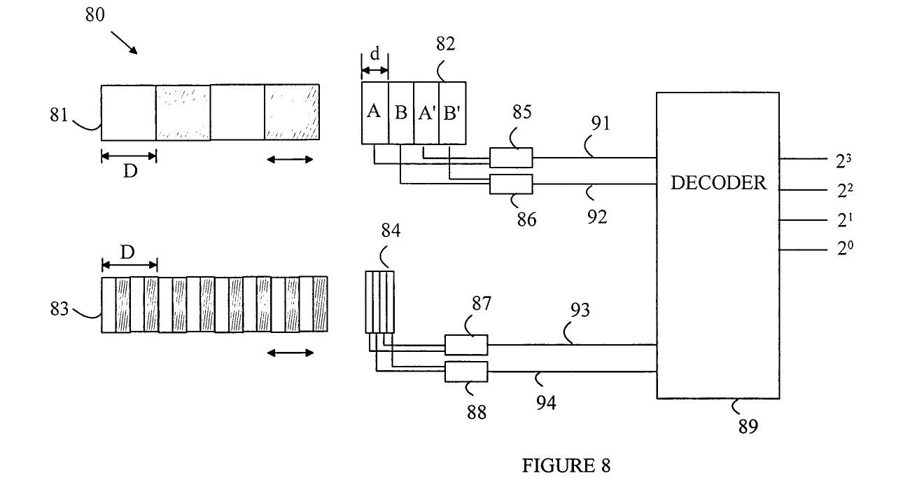

The present invention is based on the observation that the relative encoder design shown in FIG. 5 can be utilized to construct an absolute encoder with half the number of code strips and photodiode modules that must be aligned with each other when the encoder is assembled. Refer now to FIG. 8, which illustrates a 4-bit encoder 80 according to one embodiment of the present invention. Encoder 80 is constructed from two code strips whose images are shown at 81 and 83. The code strips are attached to the moving surface whose position is to be measured such that the code strip and surface move in synchrony with one another. Each code strip image is viewed by a corresponding two-channel encoder similar to the encoders discussed above with reference to FIG. 5. The photodiodes associated with the two channel encoder corresponding to code strip 81 are shown at 82, and the photodiodes associated with the two channel encoder corresponding to code strip 83 are shown at 84. Each set of photodiodes includes 4 photodiodes whose outputs are processed by detector circuits to generate two 90 degree out of phase signals. The detector circuits corresponding to photodiode array 82 are shown at 85 and 86, and the detector circuits corresponding to photodiode array 84 are shown at 87 and 88.

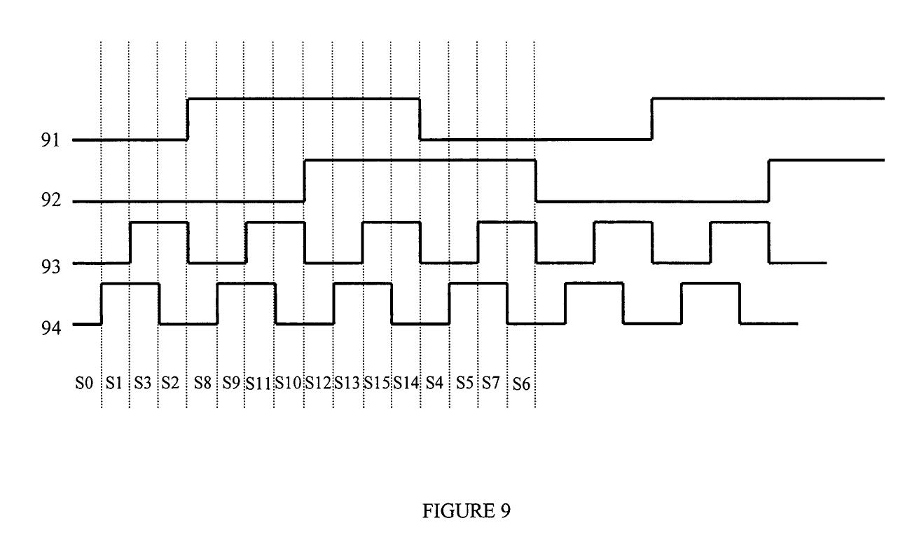

The width of the images of the stripes in code strip 81 is 4 times the width of the images of the stripes in code strip 83. Similarly, the width of the detectors in photodiode array 82 is 4 times the width of the detectors in photodiode array 84. The outputs of the detector circuits on lines 91-94 can be viewed as a 4-bit integer that cycles through 16 distinct states as the code strips move past the detector arrays. These states are shown in FIG. 9. The value of the 4-bit integers for each of these states is shown as S0 to S15 in the figure. That is, S0 corresponds to a 4-bit integer value of 0, etc. This 4-bit integer does not increase monotonically as the code strip moves. Hence, in one preferred embodiment of the invention a decoder 89 is included to convert this 4-bit integer to the conventional 4-bit state value that increases monotonically with the position of the code strip relative to the detector array.

The above-described embodiments of the present invention utilize a detector array having a complementary photodiode, i.e., A′ and B′, for each photodiode in the array. The complementary photodiodes are positioned to provide a signal that is the complement of that provided by the corresponding photodiode. This arrangement facilitates the generation of the channel signals by the detector circuits. It should be noted, however, that embodiments in which the complementary photodiodes are not present could also be constructed. For example, a fixed voltage threshold in the detector circuits can be used to define the points at which the channel signals switch between logic states. It should also be noted that in embodiments that utilize the complementary detectors, the complementary detector array can be separated from the corresponding photodiodes by a distance equal to kD, where k is an odd number.

The above-described embodiments of the present invention utilize a detector array having two photodiodes per stripe in the code strip image. However, embodiments in which more photodiodes are used may also be practiced. For example, a photodiode array having 4 photodiodes that occupy the space of one stripe in the code strip image can be utilized to construct an encoder in which each track has 8 states. In this case, the code strip image and photodiodes in the second track are ⅛^{th} the size of the code strip image and photodiodes in the first track. The two code strip encoder has 64 states in this case.

The above-described embodiments of the present invention have utilized two code tracks and detector arrays. However, embodiments in which more code tracks are utilized can also be constructed. For example, an N-bit encoder can be constructed from N/2 code tracks. Each code track has two photodiodes per stripe in the code strip image. Each code track provides two bits of the N-bit result. The width of the code strip stripes and the corresponding photodiodes decrease by a factor of 4 from track to track.

In the general case, a plurality of encoding tracks is utilized. Each track has a code strip that is attached to the surface whose movement is being measured. The k^{th} encoding track includes a code strip that is imaged onto a corresponding array of n photodiodes, where n>1. The image of the code strip on the photodiodes consists of alternating dark and light stripes having a width Dₖ. The width of the photodiodes in the k^{th} array is dₖ, where ndₖ=Dₖ. The width of the photodiodes and stripes decreases by a factor of n from track to track, i.e., Dₖ=nDₖ₋₁.

The above-described embodiments of the present invention have utilized photodiodes. However, other forms of light sensor can be utilized to detect the light intensity changes in the code strip image. For example, phototransistors may also be utilized. The present invention can utilize any form of photodetector that provides a detection aperture with the desired width.

Various modifications to the present invention will become apparent to those skilled in the art from the foregoing description and accompanying drawings. Accordingly, the present invention is to be limited solely by the scope of the following claims.

1. An encoder for measuring the position of a surface, said encoder comprising:
a first array of n photodetectors, where n>1, each photodetector being characterized by a width d₁;
a first code strip imaging system for generating an image from a first code strip attached to said surface on said first array, said image comprising alternating dark and light stripes, said stripes having a width of D₁, said dark stripes having a lower luminosity than said white stripes, wherein nd₁=D₁, said code strip image moving in a first direction with respect to said first array, said distances d₁ and D₁ being measured in a direction parallel to said first direction;
a second array of n photodetectors, each photodetector being characterized by a width d₂; and
a second code strip imaging system for generating an image from a second code strip attached to said surface on said second array, said image comprising alternating dark and light stripes, said stripes having a width of D₂, wherein nd₂=D₂, said code strip image moving in a first direction with respect to said first array, said distances d₂ and D₂ being measured in a direction parallel to said first direction, wherein d₁=nd₂.

2. The encoder of claim 1 further comprising a plurality of detector circuits, each detector circuit converting a light intensity signal from a corresponding one of said photodetectors to a channel signal that switches between first and second logic states when said code strip moves relative to said array.

3. The encoder of claim 2 further comprising a decoding circuit for receiving said channel signals and generating a digital signal that increases monotonically with the position of said code strip relative to a reference point.

4. The encoder of claim 2 wherein said first array of n photodetectors further comprises a complementary array of n photodetectors, each photodetector in said complementary array being characterized by a width d₁, said complementary array of photodetectors being positioned relative to said first array of photodetectors such that each photodetector in said complementary array of photodetectors generates a light intensity signal that is a complement of said light intensity signal generated by a corresponding one of said photodetectors in said first array.
